(19) United States
(12) Patent Application Publication
(10) Pub. No.: US 2016/0162785 A1
(43) Pub. Date: Jun. 9, 2016

(54) METHODS AND SYSTEMS FOR USING A USER CUSTOMIZABLE ARTIFICIAL INTELLIGENCE ENGINE FOR SEARCHING AND CORRELATING MULTIPLE DATABASES

(71) Applicant: Vital Statistics Inc., New York, NY (US)

(72) Inventor: Paul Grobman, New York, NY (US)

(73) Assignee: VITAL STATISTICS INC., New York, NY (US)

(21) Appl. No.: 14/564,287

(22) Filed: Dec. 9, 2014

(51) Int. Cl. G06N 5/02; G06N 99/00; G06F 17/30

(52) U.S. Cl. CPC G06N 5/022; G06F 17/3053; G06F 17/30545; G06N 99/005

(57) ABSTRACT

The present invention discloses a portal capable of gathering and correlating data spread from multiple databases in multiple relevant but disparate information data sets, and an associated method. In some embodiments, the portal can relatively easy generate a new data set including a body of relevant but disparate information to be viewed through the prism of an individual's life. For example, by intuitively generating text-based and photo/video-based information of interest to the user measured by, for example, (i) periods of time (e.g., between the user's birth date and a milestone birthday, a wedding date, or an anniversary); (ii) geographic places (e.g., the user's hometown, the place he or she went to college, favorite vacation spots); and/or (iii) interests (e.g., favorite sports teams, foods, hobbies, etc.), as well as other variables that can be built into the search engine and database and/or provided by at least one user.

### TECHNICAL FIELD

The present disclosure relates to an artificial intelligence engine and interface capable of correlating multiple databases. More particularly, the present disclosure relates to systems and methods for executing custom algorithms capable of generating a unique data set as a result of correlating the data of multiple data sets based on predefined static or dynamic criteria.

### BACKGROUND OF THE INVENTION

Many websites and web services allow a user to perform various queries and analytical functions (historical lookups, aggregate summaries, etc.) against a single data set. Examples of such sites and services include: 2010 US Census Data (http://www.census.gov/2010census/); Social Security Administration Data (http://www.ssa.gov/open/data/); and NOAA Climate Data by Location (http://www.ncdc.noaa.gov/cdo-web/).

These and other existing services are limited to deep, focused views of certain statistical data, by merely archiving the data and allowing a user to search it and/or sort it.

For example, existing search engines, like those on the Internet, have now been in common use for almost two decades and generally permit a user to search their database based on keywords or natural-language queries. Other search engines, such as Wolfram Alpha®, post results to natural-language queries from curated data within the site itself.

While these search engines provide a simple way for the user to learn more about other things or people, various limitations exist with relation to the gathering and use of information that a user will be able to receive and how it will be presented to him/her.

For example, running a search using the name “Paul Grobman” in the Google® search engine results in 11,600 hits, but no information about “Paul Grobman” other than the one-sentence excerpt quoted from each webpage. Any attempt to acquire more information or cross-reference any information requires a page-by-page review of individual webpages. Searching with the Bing® search engine, or any other search engine, yields more or less similar results.

The following provides a general overview of additional exemplary limitations of current and popular search engines. In the WolframAlpha.com, for example, searching for “Paul” will yield some information about that first name. However, putting the last name, “Grobman,” in that same database “interprets” the term as “Grossman,” and offers general statistics about that last name. When “Paul Grobman” is entered in that same database (with or without quotes) WolframAlpha.com returns the information that “development of this topic is under investigation,” clearly demonstrating its inability to interact with the user in a manner that solves the problem or expand the search beyond its static database.

Similar problems arise when more common names are used on WolframAlpha.com. If, for example, the name “Paul Smith” entered (with or without quotes), the database assumes that the query concerns a particular noteworthy “Paul Smith.” In this case, it provided information about Paul Smith of the Denver Broncos. When the search “Paul and Smith” was entered, WolframAlpha.com provided information about the popularity of the name, assuming both of “Paul” and “Smith” were surnames.

By way of yet another example, Ancestry.com gives users access to primary records such as ship manifests, census forms, voting cards, draft registration forms, naturalization forms, social security records, death records, and a smattering of other government records. As its website indicates, the focus of Ancestry.com is on the past, providing “an online service where users discover, research, and save their family history by searching our extensive databases of records in order to create family trees.” Searching for “Paul Grobman” in the Ancestry.com search engine results in 24 hits relating to various government records which can be accessed online. However, only seven of the documents related to the subject “Paul Grobman.” Furthermore, these documents related to merely the subject's birth date, some past home addresses, and a present home address.

The above-mentioned examples demonstrate there are various needs for additional novel and useful methods and data management systems that can intelligently gather and manage information from various sources to intelligently provide new information data sets to users. In particular, there is a need for a single portal using an artificial intelligence engine that is capable receiving a search query, then collect and use the collected information to search multiple databases, correlate them, and automatically and efficiently generate a novel and non-obvious dataset that represents relationships among hyper-relevant but disparate pieces of data from multiple sources.

There is another need for a user interface to manage the flow of information to and from the artificial intelligence engine.

### SUMMARY OF THE INVENTION

The foregoing needs are met, to a great extent, by the invention, wherein a system and associated method steps including a portal capable of gathering and correlating the data from multiple relevant but disparate information data sets, which may be spread across multiple databases, using user-customizable algorithms is disclosed. Moreover, according to some embodiments, using a single portal a user can relatively easily generate a body of relevant but disparate information to be viewed through the prism of an individual's life. For example, it can provide the portal with the ability to intuitively generate text-based and photo/video-based information of interest to the user measured by, for example, (i) periods of time (e.g., between the user's birth date and a milestone birthday, a wedding date, or an anniversary); (ii) geographic places (e.g., the user's hometown, the place he or she went to college, favorite vacation spots); and/or (iii) interests (e.g., favorite sports teams, foods, hobbies etc.), as well as other variables that can be built into the search engine and database or provided by the user.

According to one aspect of the present disclosure, the system and associated methods provide for executing custom and user-customizable algorithms for searching and correlating databases in order to generate a new correlated data set including information from various databases. These algorithms may be embodied in a portal described in this application as a “wizard.” In one embodiment, the wizard may produce any number of unique, customized datasets in response to information entered by a user on behalf of a “recipient,” who may be the user or another party or group. Moreover, the user, or users, may be guided by prompts preprogrammed into the wizard or independently generated by the wizard based on the input by the user, and displayed on one or multiple screens.

In another embodiment, the wizard may allow users to create products across multiple media based on unique sets of personalized statistical information generated by artificial intelligence algorithms in the wizard. The artificial intelligence engine of the wizard allow it to independently determine the type of databases it will search and how it will organize and correlate the data to generate a new data set. The wizard may search its own database, the Vital Statistics® Database, along with many other databases, and may generate a large and richly correlated dataset of information that is relevant to the user's input.

In yet another embodiment, the wizard may use an Application Program Interface (API) to mine content residing on various private or public data repositories.

According to one or more some aspects, a system for an intelligent engine portal is disclosed. The system including a processor in communication with a communications network and a memory, and the memory storing software code executable on demand. The software code with the processor being operative to: receive an input from at least one user; qualify one or more queries based on the received input from the at least one user; execute the one or more qualified queries: access, based on the executed one or more qualified queries, multiple databases; and correlate and combine results from the multiple databases for the generation of a new data set that can be presented to the at least one user.

According to additional aspects, an associated method for the intelligent engine portal is disclosed. The method including: receiving an input from at least one user; qualifying one or more queries based on the received input from the at least one user, executing the one or more qualified queries; accessing, based on the executed one or more qualified queries, multiple databases; and correlating and combining results from the multiple databases for the generation of a new data set that can be presented to the at least one user.

In yet additional aspects, the associated method including: receiving an input from at least one user; accessing and gathering data, based on the input from the at least one user, from at least one social media profile of a recipient; accessing, based on the gathered data from the at least one social media profile, multiple databases; and correlating and combining results from the multiple databases for the generation of a new data set that can be presented to the at least one user.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 is a flow chart representing an exemplary user-input data flow for providing input to the wizard, according to some aspects of the present disclosure;

FIG. 2 demonstrates an exemplary schematic representation of the exchange of information between a user and the wizard, according to some aspects of the present disclosure;

FIG. 3 is a flow chart representing an exemplary user-input data flow for using the output of the wizard, according to some aspects of the present disclosure.

FIG. 4 illustrates a schematic of a processor that may be used to implement some embodiments of the present disclosure;

FIG. 5 illustrates an schematic representation of three execution phases the system can implement according to some aspects of the present disclosure;

FIG. 6 illustrates schematic representation of an exemplary query qualification phase according to some aspects of the present disclosure;

FIG. 7 illustrates a schematic representation of an exemplary execution of the queries phase according to some aspects of the disclosure; and

FIG. 8 illustrates a schematic representation of an exemplary combine, rank, and display results phase according to some aspects of the disclosure.

### DETAILED DESCRIPTION

The below description of the invention is illustrative only, not restrictive. Various additional embodiments, which could be used in combination with the embodiments disclosed herein, could be apparent to those skilled in the art. Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

Referring now to an exemplary embodiment of the disclosure, the user may begin by entering basic identifying information about a recipient, who may be the user or another person or group of people. This identifying information may include, without limitation, the recipient's name, date of birth, hometown, ethnicity, vocation, interests, habits, appearance, etc. The intelligent engine portal, also referred to herein as a “wizard”, may then interact with the user in various ways in order to solicit additional information about the search.

Once the wizard determines that it has enough information about the nature of the search, the wizard may then query its own database and multiple other databases to retrieve text and/or photo/video-based data to be used by the wizard in order to generate a unique output that is individually tailored to the recipient. For purposes of this disclosure, the wizard's database and/or one or more of the multiple other databases are data repositories of a set of integrated objects, which may also include flat files that can store data.

The wizard may also prompt the user to enter additional information in order to further identify interests or other personal attributes of the recipient. The wizard may use this additional information to modify the operation of the artificial intelligence engine within the wizard, enabling searches that are more-refined and providing an even richer correlation of data residing in disparate databases.

The wizard may act on static or dynamic data. It is capable of automatically refreshing past queries so that, if information in any of the source databases is updated after a user runs a given query, that query's results could be automatically updated. Further, the wizard may store past queries and make them accessible for further cross-querying. Past query results may be indexed and become searchable by the wizard's primary search engine.

The results of a wizard query can be viewed either online or offline, in a variety of forms. For example, a personal dataset generated by a given query may be viewed as a simple list, or the user may put the results into a timeline, quiz, game, graph, video montage or some other form.

In another embodiment, the wizard may also enable collaborative queries based on input from more than one person/user, wherein each person in a group of users may enter different information about a recipient. This collaboration may take place either in person or remotely: over the internet, an intranet, or any other type of communication network, which may include, but is not limited to, a cellular network, a LAN or WAN; or a social media engine such as Facebook®, Tumblr®, Vine®, Feed®, or Instagram®. Accordingly, it is to be understood that an input can include information gathered (via questionnaire, social media profile, etc.) about the recipient/user and/or information in any known data store and/or using data and rules learned by the wizard's artificial intelligence engine.

In another embodiment, the wizard may allow a user to create one or more products from the datasets generated. The user may choose from a variety of templates for creating several different products, which may include, but are not limited to, a personal or business webpage on a social networking site, a biography of the user or recipient, or a keepsake such as a printed mug or T-shirt, or a book, calendar, poster, or baseball cap.

The wizard's refresh and storage capabilities and its rich cross-querying functionality can enable even more powerful outputs. For example, in the case of communities of wizard users linked by multiple, perhaps very subtle, connections and similarities, the wizard may cross-query these users' primary wizard datasets and produce secondary or tertiary cross-comparisons. This further data-analysis capability could help users identify patterns of similarity and or connections between themselves and others that may not be obvious from their initial data input.

As described above in certain exemplary embodiments, the wizard's methods and systems can consist of algorithms for structuring queries of multiple databases, discerning non-obvious relationships amid the output information, and refining queries based on both database output and additional user input. These algorithms and other attributes comprise the above-described artificial intelligence engine that produces a unique body of personal information relevant to a recipient.

These capabilities, which can go far beyond a human's capability through any kind of mental steps, make the wizard's methods and systems very different from, and significantly more advanced and intelligent than, those of other database engines. The wizard's algorithms represent a unique and novel way of combining, correlating, and sifting data from a large, diverse, and constantly expanding set. Moreover, the algorithms can enable a user to generate a rich and unique set of data about him- or herself or another person and to create products that can reflect the distinctiveness of an individual human being.

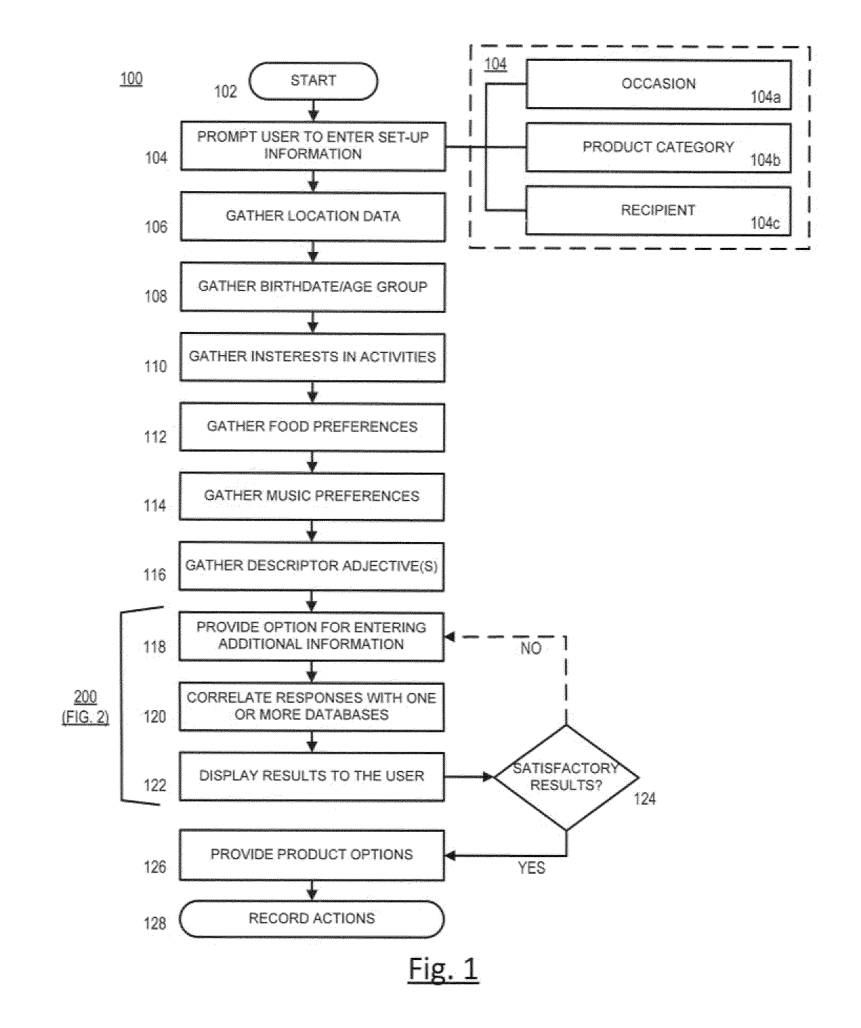

Referring now to FIG. 1, a flow chart 100 representing an exemplary user-input data flow for providing input to the wizard is depicted. Beginning at step 102, when the user is on the Start page, at 104, he or she will be prompted to enter set-up information. Prompts for set up information can include, but are not limited to: an occasion selection 104a, a recipient 104b; and, a product selection 104c. For example: what's the occasion?, who is it for? and, what do you want to make? In some embodiments the user must answer all three questions, in any order, before proceeding, to enable the wizard to use the information to correlate specific information according to the responses.

Referring back to step 104a, on the What's the occasion page, the user will be prompted to select one of many holidays and special occasions, such as “Birthday,” “New Baby,” “Graduation,” “Anniversary,” a mood (e.g., “Humorous,” or “Formal”), or “Any Occasion.” The selection may be one or a combination of two or more made from a dropdown menu, a typed response, a checked box, and the such. Similarly, a product category selection may be made at 104b. The product category can include, for example, a song, a movie, a t-shirt, a profile, a book, a poster, a greeting card, or any such product where the new data set can be presented. Information of the recipient at 104c may include, for example, a first and a last name of an individual, a group of people with a shared interest or quality, a type of animal, plant, or the such.

Following the user may then choose to optionally enter additional information about the recipient that can be used to generate the new data set for the selected product.

At step 106, geographic location data may be retrieved, for example, by asking one or more users—“What is [name]'s hometown?”, prompting the user, for example, to enter a city, zip code, state, and/or country.

At step 108, the user(s) may be prompted to enter the birthdate or age group of the selected recipient. For example, the wizard may ask When was [name of recipient selected] born? generating a space for the user(s) to type a birthdate or select an age group.

At step 110, the user(s) may be prompted to enter interests in activities of the recipient. For example, by asking—“What are a few of [name]'s interests” then providing the user(s) the opportunity to type one or more interests, such as hiking, skiing, crocheting, the name of a college or professional sports team, etc.

Similarly, at step 112, the user(s) may be prompted to enter food preferences. Food options may include, for example, one or more foods, such as pizza, Mexican, hot dogs, French food, Italian food, etc.

At step 114, music preferences can be gathered. Music preferences can include the name of a bands, musical artists, or genera. Finally, at step 116, adjectives about the recipient may also be entered. The user(s) may be prompted to enter or select three words or phrases that best describe [recipient's name].

At step 118, the user(s) can enter any other pertinent information about [recipient's name]. According to some aspects of the disclosure, all or some of steps 104-116 may take place via the use of a social media platform and this step is also within the scope of the disclosure. For example, a prompt may link a social media profile of the recipient and/or recipient's connections and gather data including the aforementioned. All of the collected responses may be weighed against each other to determine which databases to search and how the information can be correlated. Data from the multiple databases can then be retrieved and correlated according to the user(s) entered responses 120. At step 122, a new data set can then be generated using the retrieved information and the results can optionally be displayed to the user as a preview. At 124, the user may provide additional information 118 when the results are not satisfactory or the user(s) would like to shift the focus of attention to a specific area of interest. If there results are satisfactory, at step 126, the system may provide the information for the selected product along with additional product options for which the new data set may be fit. Finally, the originally selected product and/or the additional product options may then be produced for the user(s) using the new data set (i.e. results), and at 128, the options selected and product(s)' information may be collected for the system to self-learn preferences for future uses.

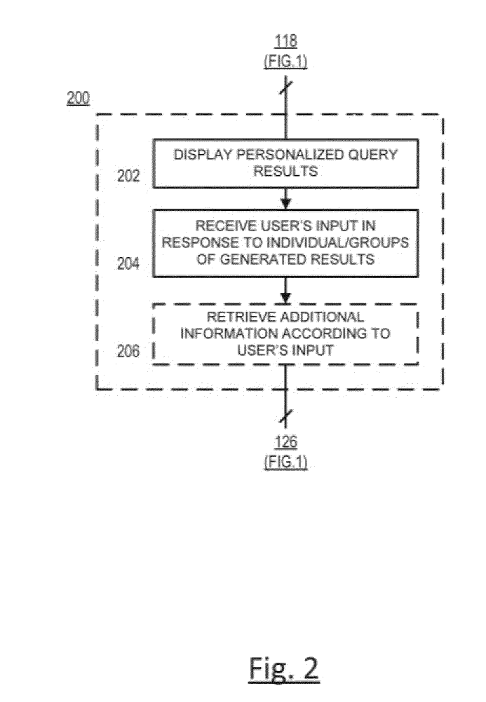

Referring now to FIG. 2, a schematic representation 200 of an exemplary exchange of information between a user and the wizard is depicted. In particular, the exchange of information may be done to filter unwanted data out of the new data set and/or provide the opportunity to the user to expand in areas of interest. Beginning at step 202, the system may display the personalized query results, for example, in a preview mode. These results and topics can be conditional based on user's responses to system's information prompts. In some embodiments, based on the results preview displayed, at step 204, the system can receive additional inputs from one or more users. Some options may include for example, Give me more about [name of topic]; I'm not interested in [name of topic]; and/or Start Over to return to the Start page.

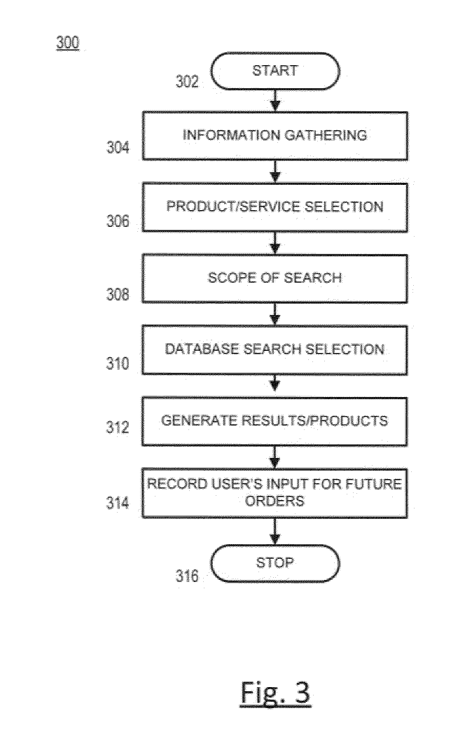

Referring now to FIG. 3, a flow chart 300 representing an exemplary user-input data flow for using the output of the wizard is depicted. In particular, the data flow can be done in order to customize or generate a product that includes the new data set generated by the wizard. Beginning at step 302, the wizard may be engaged by a user. Once the wizard is engaged, information gathering may occur using prompts preprogrammed in the system, as it has been previously described. At step 306, the user can choose from a list of products and/or services on which wizard new data results may be printed and/or presented. In the present example, the product and/or service may be selected prior to the generation of the new data set by the wizard and may be used to limit and focus the data that is included in the new data set. This can include allowing the user to choose more or fewer wizard results to appropriately fill the chosen product template. For instance, a calendar template might allow a larger number of results than a one-page poster. At different stages during the creation or tailoring of the new data set the user may further customize the design of the selected product. Aspects available for customization could include, for example: color selection, type face changes, or personalized text. This may typically occur by providing the user with an on-screen preview of the customized selected product before the product is available for immediate purchase or ordering.

At step 308, the product selection and responses from the user can be used to define the scope of the search. For example, depending on the product and/or service selected the amount of data that can be included in the new data set for the particular product may be limited. Similarly, at step 310, the databases may be filtered and/or limited based on the product and/or service and the user's preferences. As previously mentioned, at step 312, product/results may be previewed including a generated customizable new data. At step 314, inputs from the customization and/or approval from the user may be recorded in the system in order to allow the system to self-learn preferences and implement them in future orders.

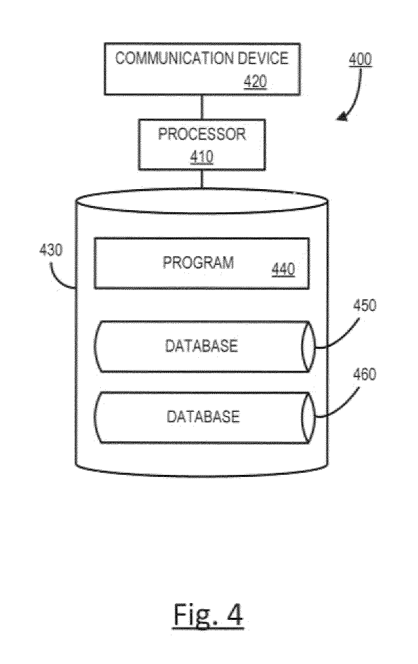

Referring now to FIG. 4, a schematic diagram of an exemplary system controller 400 that may be used with some embodiments of the present disclosure is illustrated. The system controller 400 includes a processor 410, which may include one or more processor components coupled to a communication device 420. In some embodiments, a system controller 400 can be used to communicate with one or more user's interfaces and the databases via a communication channel. The system controller 400 can include one or more processors 410, coupled to a communication device 420 configured to communicate logical signals via the communication channel. The communication device 420 may be used, for example, to access multiple databases from third parties, execute prompts to initiate the actions described in the present disclosure, and allow communication between one or multiple users for the ordering of a product and/or service including the generated data set.

The system processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 can store a program 440 for controlling the processor 410. The processor 410 performs instructions of the program 440, and thereby operates in accordance with the present disclosure. For example, the processor 410 may transmit data including, for example, the receipt and combination of data to generate queries and new data sets. Accordingly, the storage device 430 can also store statistical data, user's information, profiles, etc., in one or more databases 450-460. Moreover, according to some embodiments, the system can be a distributed system to optimize aspects of the wizard. For example, in a case of API consumption, each step executed by the wizard could run in an entirely separate computing environment (i.e., different servers and/or databases on different networks in different physical locations).

Overview of Capabilities

The following description of certain embodiments of the invention further illustrates the richness of the information that the wizard is capable of finding when the user enters simple, basic data (e.g., first and last name, birthdate, home town, etc.) on behalf of the recipient. This example is meant for illustration only and is not intended to limit the scope of the wizard's capabilities.

First and Last Name

When the user inputs only a first and last name, the wizard intuits that the user wants data regarding that first and last name. The wizard searches internal and external databases to generate data relating to that name. The data could include, without limitation, any or all of the following data categories listed below:

The rank of that first name among the most popular names in the U.S. in the current year; the year in which that first name was ranked highest in the U.S.; the year in which that first name was ranked lowest in the U.S.; the rank of the last name among all last names in the U.S.; the origin, etymology and meaning of the first and last names; the ranking of those first and last names among the most popular in other countries; the number of hits on Google® for the person's first name (“Paul”), last name (“Grobman”) and full name (“Paul Grobman”); the number and names of geographic places with the same name, along with pictures of those places; the spelling of the person's first and last name in different alphabets (Arabic, Cyrillic, Hebrew, etc.); and/or the number of points generated by the person's first and last name using Scrabble pieces; the rank of the person's first name among those names that are predominantly given to white people, or black people (which could, for example, be based on a study mentioned in the book Freakonomics®).

The data could also include: the rank of the most famous people with the same first/last name throughout history based on the number of hits they have on Google (as well as pictures of those people); status of the name as a domain name—for example, whether the person's first or last name with a “.com” (e.g., “Paul.com”) is taken; what other URLs with those names are still available; and, if not available, whether the domain name is for sale and, if so, its asking price; whether the name is associated with a sign or other image, wizard could search its picture database, which could be populated with pictures of signs with names (e.g., “Paul Street,” “Paul's bar,” “Paul's boutique,” etc.) and the place where the sign is located; and/or information on the letters in the person's name: the year in which they were first used, their frequency in the English language, and other information (e.g., the name for the dot above a small “i” is a “tittle.”)

In addition, the wizard can analyze the name to make assumptions about the user's race, religion, and/or ethnicity based on statistics derived from Census Bureaus in multiple countries. For instance, the wizard will ask a person with the last name “Martinez” or “Hernandez” if they are of Mexican origin, a “Washington” or “Jefferson” whether they are African-American (for example, census data indicates that 90 percent of people named Washington and 75 percent of people named Jefferson are African American), a “Nguyen” if they are Vietnamese (95 percent are), or and a person with the first or last name “Mohammed” if they are Muslim. If the answer is yes, the wizard could find data that may be relevant to a person of that background.

Date of Birth

When the user inputs a date of birth, the wizard intuits that the user wants to generate data related to his or her birthday or that of the recipient. The wizard searches internal and external databases to generate data relating to that date. The data could include, without limitation, any or all of the following data categories listed below:

Rank of the user's birthday based on a database of the most common birthdays; the date and year the user was born in different calendars (Chinese, Jewish, Muslim, Buddhist, etc.), as well as the current date and year; the age of the user in dog years (or the wizard will prompt the user to choose another animal or species); the number of births in the world in the year the user was born, as the number of deaths, and the increase in world population.

The data could also include the (i) Number of days the recipient has been alive, (ii) ratio between the number of days the recipient has been alive and the approximate number of days the world has existed; and/or (iii) number of days the recipient still has to live, considering the average life span of American males in 2013.

The data could also include, the top-selling song in the week the user was born, as well as the top-selling album, the top-grossing movie, and the top-rated television show; the people on the covers of top-selling magazines in the week the user was born, along with pictures of those covers; pop culture information: e.g., the host of SNL® in the week the user was born, as well as popular hairstyles, fashions, fads and crazes; popular catch phrases from the time; new words that were introduced that year; the top news story on the day the user was born, along with a picture of the newspaper article; and/or the closing price of the stock market on the day the user was born.

The data could also include the cost of certain items in the year the user was born versus the cost today. The data generated will depend on other data provided by the user, such as geography and team allegiances. For instance, if the recipient is from Macon, Ga., and is identified as an Atlanta sports fan, the wizard will generate data about the cost of Atlanta Falcon tickets in the year the recipient was born versus their cost today. Other interests identified by the user (skiing, hamburgers) will generate other price comparisons.

The data could also include, the highest and lowest temperatures in the world on the day the user was born; the phase of the moon on the day the person was born (e.g., from http://eclipse.gsfc.nasa.gov/phase/phases2001.html); the Academy Award Winners in the year the user was born, as well as sports champions, Grammy Award winners, and Nobel Prize winners; studies based on month of birth (yielding, for example, traits common to persons born in the same month); the best-selling toys in the first 10 years after the user's birth, along with pictures of those toys; and/or pictures of the way things looked in the year the person was born: cars, advertisements, the President, phones, music players, fashions.

If the recipient is a car enthusiast, the data could also include pictures of all cars sold in America on the year of the entered date. The data could also include inventions in the year the person was born; the percentage of people in person's country who had access to various household items (refrigerator, stereo, computer, cellphone, WIFI, stereo, etc.) in the year the person was born; polls and surveys of public opinion the year the person was born; weird and unusual things that happened that day and year (from Vital Statistics database); and/or pictures of famous people who were born on the same day (from Vital Statistics Picture Database)

Wizard can also measure the period between the date of birth and the present date (or some other date entered by the user) and searches internal and external databases to generate historical data from the period of time between those dates. The following examples suggest the scope of the wizard's capabilities and are not intended as an exhaustive or complete list: The number of times the stock market has gone up on the user's birthday over the years, versus the number of times it has gone down; the highest- and lowest-performing stocks between the user's birthday and the selected date; the average gain or loss of the stock market on the user's birthday; first years (e.g., the first year that audio CDs outsold vinyl records); last years (closings of stores or companies, etc.); and/or peak years (for example, peak year for sales of record albums)

In one embodiment, the wizard can generate a series of pictures or videos in Timeline/chronological or other form showing the modernization of technology and other things during the period from the user's birth to the present—for example, audio technology such as the phonograph, tape recorder, cassette, 8-track player, or Walkman. The user can ask the wizard to incorporate multiple subjects: fashion, civil rights, women's rights, gay history, Christian history, sexual history, etc. The user can have separate Timelines running parallel to each other on different subjects, or can incorporate them into a single Timeline, incorporating milestones relevant to the user's or recipient's life.

The wizard can also search back in time from the birth date to generate historical data related to the recipient's life from before the user was born. For example, the wizard can find how many times the stock market has gone up or down on a given historical date or span of time.

In addition to generating data based on information entered by the user, the wizard analyzes individual pieces of information in relation to one another to generate new data. For instance, the wizard will consider user name along with date of birth to generate data pertinent to that relationship, such as the rank of the users first name in the year he or she was born, or the highest and lowest rank of the user's first name between his or her birth date and the present and the years in which those rankings occurred.

Geographic Data

When the user inputs the hometown without additional information, the wizard intuits that the user wants to generate data related to a given geographic place, and searches internal and external databases to generate data relating to the recipient's home(s) and geographic location(s). The following examples suggest the scope of the wizard's capabilities and are not intended as an exhaustive or complete list:

A list of famous residents and alumni of the town (by entering “notable residents” and the name of the town in a Google® search); population and average home value and size in the user's place of birth and current hometown; and/or close-up and satellite pictures of the home at the entered address from Google Streetview®, Google Maps® and Google Earth®. If the user does not know the address, the wizard may enter the recipient's name in an external database (e.g., the White Pages) in order to find the recipient's current address.

Additional data could include a map showing the location of each of the person's homes during his lifetime, including college, and tracing the person's migration, using the wizard's Mapping Function; addresses of the person's friends, from user-input names. The wizard uses the above-mentioned external databases to locate their childhood addresses and uploads a picture of the house(s) from Google or Bing.

The wizard may also search Wikipedia®, Flickr®, Google Images®, e-Bay®, and other external sites for pictures of notable places in the person's hometown, including pictures of stores and other neighborhood features as it they looked when the person was younger, as well as pictures from Google® street view or Bing® showing what the town looks like today. In addition, the wizard has a database of the history of various places in Timeline form, enabling the user to create a timeline of local history, with one-click access to the town history's and vintage pictures.

The wizard can also analyze pieces of demographic and geographic information in relation to one another to discern distinctive relationships. For example, from the person's name and hometown, the wizard will generate data from a database of the most common first names by location to show the popularity of the person's first name in his or her home city or state.

Weather

Using historical daily weather data for thousands of locations around the world, the wizard uses an algorithm to generate information such as: Weather in the person's birthplace on the person's day of birth; number of times it has been sunny in the person's hometown on his/her birthday from birth to present; number of times it has rained in the person's home town on his/her birthday from birth to present; number of times it rained and/or was sunny in the person's hometown on the day before or the day after his/her birthday from birth to present; and/or the average temperature on the person's birthday from birth to present

Sports

From birthplace and home town information, the wizard may identify the nearest professional and college sports teams. For the home town of Macon, Ga., for example, the wizard identifies Atlanta as the nearest professional sports city, and asks: “Is [recipient's name] an Atlanta sports fan?” If the answer is “Yes,” the wizard searches its databases for information on professional sports teams, generating information such as: Number of championships won by Atlanta teams since the recipient was born number of championships won by Atlanta teams before the recipient was born; overall record of each professional team in Atlanta (e.g. the Braves, baseball; the Falcons, football; and the Hawks, basketball) since recipient was born to the present; if the user's birthday occurs during a particular season, the wizard will generate data identifying the win/loss record of each Atlanta team on the user's birthday; and/or days since each of the last world championship for each of the recipient's favorite teams (e.g., “Number of days since the Atlanta Falcons last won the Super Bowl”).

If the user answers “No,” the wizard asks: “Not a sports fan? Or not a fan of Atlanta teams?” If the person indicates that he/she is a fan of teams located in another (or several other) cities, the wizard uses the same algorithm as described above to generate data relevant to the recipient.

The wizard may perform the same analysis applies with respect to college sports teams. For the hometown of Macon, Ga., the wizard identifies the Georgia Tech and the University of Georgia as the nearest major universities and asks: “Is [person's name] a Georgia Tech or University of Georgia fan?” If the user picks either team, the wizard uses an algorithm to conduct a search of its college sports database to generate data on:

Number of NCAA championships won by the university's sport's team since the user was born; overall record of the university's football and basketball teams from the day the user was born until the present; and/or if the recipient's birthday occurs during a particular season, the win/loss record of the university's football and basketball teams on that day.

School

The wizard could locate school data from the recipient's childhood address. If the user does not know the address, the wizard could search WhitePages.com, PeopleFinders.com. Redaris, Ancestry.com, Instantcheckmate.com, classmates.com and Pipl to locate the recipient's childhood home town. With that information, the wizard has the ability to search external databases to identify the person's school district. It can then produce a picture of the elementary school, middle school, and high school attended by the user or recipient, or a choice of pictures of schools if there is more than one school in the district.

The wizard can also search Classmates.com and e-yearbooks.com for high school yearbook pictures of the recipient and upload the picture or pictures it finds. The wizard can also generate a list of famous people who attended the school (by putting in “notable alumni” and the name of the high school in Google).

College

If the user pro-tides the recipient's college or if the wizard obtains that information from LinkedIn®, Facebook®, or another external database, the wizard will generate pictures of notable landmarks from the school. Even if the years of attendance are not provided by the external website, the wizard will assume years of college attendance for a four-year period starting 18 years after the recipient or user's birth, and will generate information relating to the recipient's college, such as the scholastic ranking of the college, the ranking of the college among the biggest party schools in America, the ranking These same rankings (academic and party) in the year the person went there? of the college in the year the recipient began attending, average SAT and ACT scores Average scores of entering freshmen? in the current year and in the years the recipient went to school, and noteworthy facts about the school, such as traditions, customs, and notable alumni.

Work

If the user provides the recipient's place of work, or if the wizard obtains the work history from LinkedIn®, Facebook®, or another external database, the wizard will produce pictures of each of the workplace(s) from either internal or external databases (such as Google Streetview®). The wizard will also generate information about the recipient's work life, such as statistics regarding the profession (from the Vital Statistics database). For example:

The number of people in the recipient's home country in that profession compared to other selected countries; surveys regarding satisfaction of members of that profession; surveys regarding how the profession is viewed by others; and/or average length of the person's commute (from Google Maps or similar database). The wizard's mapping function can also diagram the commute from the user or recipient's home to his workplace

Family

The wizard will ask the user if the recipient has siblings and what place he occupies in his family's birth order. If the user cannot furnish this information, the wizard searches WhitePages.com, PeopleFinders.com, Redaris, Ancestry.com, Instantcheckmate.com, and Pipl. From this information, the wizard will find data relating to the recipient's birth order, such as findings from studies devoted to effects of birth order and upbringing with siblings (for example, traits associated with being an oldest, middle, or only child).

The wizard will also ask the user if the recipient has children, and if so how many and what sex. From this information, the wizard will generate information of interest, such as the average number of children in families in the recipients country and other selected countries; ideal number of children, according to recent studies; traits associated with daughters and sons; estimated cost of raising each child to the age of eighteen; and/or traits associated with birth order.

Cars

From information about the recipient's current car model, the wizard will generate a picture of the car along with such facts as the first year it was of offered for sale, number sold, etc. With more information from users (siblings, significant others), the wizard can produce pictures for each of the cars the recipient has owned up to the present, including his family's cars. This information can be displayed in Timeline form.

Food

The wizard will ask the user if the recipient has any favorite foods, or a favorite restaurant and favorite dish. The wizard will generate a picture of the restaurant, along with facts about the recipient's favorite food (from the Vital Statistics database).

Other User-Provided Data

The wizard will prompt users to supply other relevant bits of information. The following examples suggest the scope of the wizard's capabilities and are not intended as an exhaustive or complete list:

The wizard could ask users for a list of the recipient's relatives, such as grandparents, aunts, uncles and cousins. The wizard will place each one into a family tree, and will ask the user if he or she would like the relatives to be contacted about supplying a photograph to go with the name. If the user answers “Yes,” the wizard will show the user a form email requesting a picture and expressing the purpose. The email will then be sent, with a return address which allows the picture to be automatically uploaded into the recipient's product. The wizard will ask users for the hospital in which the recipient was born. If the information is provided, the wizard generates a picture of the hospital.

The wizard may solicit from users all kinds of other bits of information: for example, names of camps and religious institutions the recipient attended, the church where he or she was baptized or confirmed, teams and clubs he participated in, pets, the place where the recipient had his or her first drink, the first time he or she made love, names of former girl- and boyfriends; the place where he or she proposed marriage, the place where he or she spent the wedding night. For each of these, the wizard will search the Vital Statistics database and produce relevant statistics and other information, which may be displayed in Timeline form. The more information provided, the more the wizard can enrich the recipient's unique life story, including routines, passions, and interests.

### Other Special Wizard Features

The wizard may include various unique graphic and information-based features, including:

### Wizard Anatomy Function

The wizard's anatomy function could provide the user with a schematic of a human body, allowing the user to identify notable physical features of the recipient, or areas of the body for which the user desires information. If the user hovers over the head, for instance, the wizard will highlight or identify mouth, nose, chin, eyes, hair, brain, etc. Statistics about each body part highlighted will come up on the side of the screen.

As part of the wizard artificial intelligence engine, for a given physical feature, the wizard could ask a question such as, “What is notable/special about [recipient's] nose [or eyes, or hair, or other body part chosen?]” The wizard could provide a list of potential answers from which the user may choose; for example: “Its beauty”; “Its size”; “Its shape”; or “Other,” with a space for explanation. These prompts will vary according to the body feature chosen. If the user chooses “hair,” for example, the wizard will ask: “What is notable/special about [recipient's] hair?” and will provide a list of answers like, “Its beauty”; “Its color”; “Its length”; or Its style.” If the User chooses (by hovering over) “Its color,” the wizard will generate a list of hair colors. If the User chooses “Its style,” the wizard will generate a list of styles (e.g., “curly, Mohawk”).

Based on information entered by the user and processed by the artificial intelligence engine, the wizard will generate data relating to the recipient and the particular physical features chosen (for example: “Original color of [recipient's] hair;” “Number of years she's been a blonde;” etc.). It will relate that information to general statistics about those physical features (for example, “Percentage of women in the U.S. who have natural blonde hair;” “Percentage of women in the U.S. who change their hair color”).

### Wizard Brain Function

The wizard could provide the user with a schematic of a human brain, with the prompt: “If this is [recipient's] brain, what does he think about, and what percentage of time is spent on each of those thoughts?” The user may enter various topics and the percentage of time the recipient spends thinking about each of them (for example, Work: 35%; Sex, 20% Twinkies: 15%). Each thought will appear on the wizard Brain Schematic as a portion of the brain, and those brain portions will automatically change in size based on the percentages put in by the user. As the user uses the wizard brain function, statistics about the brain will come up on the side of the screen. The wizard will also provide the user with a schematic of the body, which will work similarly to the brain schematic: the user can enter information to show what the recipient's body is composed of e.g., 14% pizza, 22% sweat, etc.).

### Wizard Picture Function

Using its picture function, the wizard's algorithm could tailor pictures according to the information provided by the user. For example: (1) If the recipient is female and the user indicates an interest in gay statistics, the wizard will provide pictures of women and gay female relationships; and/or (2) If the name suggests that the recipient is black (or the user provides that information), the wizard will provide a greater percentage of pictures of black people than people of other races. Similarly, if the recipient lives in Spain, the wizard will show pictures captioned in Spanish. For instance, for a statistic about a town that sends uncleaned dog feces back to the owners by mail in a box marked “lost property,” the wizard will provide a picture of a “clean up after your dog” sign in Spanish, or in whatever language the recipient speaks.

The wizard will also offer other choices respecting pictures. The wizard will ask, for example, whether the user cares if there are generic pictures with people other than the recipient (show example) or whether they would rather have only pictures of places and things and not people. In addition to pictures from the Vital Statistics database, the wizard could allow the user to easily upload his or her own pictures into the product being created.

### Wizard Mapping Function

With its mapping function, the wizard can display static maps and/or geographic points, such as the recipient's birthplace, home town, current home, workplace, and the locations of the homes of friends and relatives. The wizard mapping function will also display movement—for example, a map depicting the recipient's progression from the hospital where he or she was born, to his or her first home, to school, to college, to the place where he or she proposed marriage, to his or her current home.

### Other Wizard Algorithm Functions

The wizard's algorithm will automatically tailor the generated data in these ways, depending on the information provided by the user. The following examples suggest the scope of the wizard's capabilities and are not intended as an exhaustive or complete list:

### General

The data generated by the wizard can be neutral in emotional tone, or it can be sentimental, sincere, humorous, or sarcastic, or a combination of these qualities. The wizard will provide the user with a sliding bar (similar to the type of functionality that allows a listener to regulate audio volume), with “Sarcastic/Humorous” on one end of the scale and “Sentimental/Sincere” on the other. By placing the button in the desired region of the scale, the user can adjust the emotional tone of the product.

### Birthdays

If the date of birth provided by the user indicates that he or she is creating a product for a recipient's milestone birthday, the wizard will provide several choices on screen and provide a different set of statistics depending on the response. For example: “Do you want to tease [name of person] for getting old?” “Do you want to convince [name of person] that [he or she] is still young?” “Or do you want to do a little of both?”

### Gifts for Relatives

If the information provided indicates that the user is brother, sister, parent, or child of the recipient, the wizard will generate data from its database relating to brothers, sisters, parents, and/or children, as applicable, and will tailor the emotional tone of the feedback based on the user's selection (see General, above). For example, if the recipient is a sibling and the user sets the tone more toward “Sarcastic/Humorous,” the wizard will generate data such as “Species that eat their siblings.”

### Gifts for Spouses and Mates

If the user is a husband, wife, or boyfriend or girlfriend of the recipient, the wizard will generate data from its database tailored to that status and relationship. The data will be further tailored if the user discloses that the mates are gay or lesbian. In addition, the wizard will provide another sliding button denoting a scale between “Very Steamy” and “Very Sappy.” The closer the user places the button toward Steamy, the more data about sex the wizard will provide. The wizard will also generate humorous data if requested (e.g., “Species that eat their mates”).

### Gifts for New Babies

If the information provided indicates that the gift is for a new baby, the wizard could generate data from its database tailored to that status, using many of the functions described above. For example, data will be tailored to the sex of the child, and if the user desires, the wizard will refer to the recipient in the first person and will shape the emotional tone according to the user's choice.

### Vital Statistics Database

### 1. Hand-Selected Statistics

The Vital Statistics database can contain more than 25,000 hand-selected statistics stored as human-readable sentences. Each of these statistics consists of a “question” statement, an answer, a source with date, and an optional backstory. These statistics could be organized into twelve top-level categories: Animals, Arts & Entertainment, Business, Food & Drink, Government, History, Media, Nature & Environment, People & Society, Places, Science & Technology, Sports. Each may also be assigned one or more descriptive/organizational tags. For example:

TABLE 1

| Question Statement | Answer | Source | Backstory |
|---|---|---|---|
| Year the term “doggie bag” first | 1964 | Newsday, | None |
| entered the Oxford English | | Apr. 6, 2005 | |
| Dictionary | | | |
| Percentage of Americans who | 57% | Washington | According to survey of |
| believe global warming “is | | Post, Jan. 28, 2010 | Americans conducted in |
| happening”, according to a 2009 | | | October 2009 by Yale and |
| survey | | | George Mason universities, |
| | | | 57% of respondents believed |
| | | | global warming “is |
| | | | happening”, compared to 71% |
| | | | who said so in October 2008. |
| Number of NFL games that | 268 | USA Today, | Junior Seau played 20 years as |
| Junior Seau played linebacker, | | May 3, 2012 | an NFL linebacker until his |
| the second most in NFL history | | | retirement after the 2009 |
| at that position | | | season, playing 268 games at |
| | | | the position, behind only Clay |
| | | | Matthews in terms of |
| | | | longevity. |

### 2. Detailed Table-Based Statistical Data

The Vital Statistics database could also contain detailed statistical data loaded from external sources, stored as relational database table(s), with rows and columns varying with the structure of each data set. Each table-based data set has an associated template and algorithm that allows translation of raw data rows into human-readable statements, similar to the hand-selected statistics described above. For example, the data set “First Name Popularity by Year from the US Social Security Administration” is stored in a database table structured in this way:

TABLE 2

| Year | First Name | Gender | Count |
|---|---|---|---|
| 1880 | Mary | F | 7,065 |
| 1880 | Anna | F | 2604 |
| 1880 | Emma | F | 2,003 |
| 1880 | John | M | 9,655 |
| 1880 | William | M | 9,533 |
| . . . | . . . | . . . | . . . |
| 2008 | Carinna | F | 8 |
| 2008 | Zamian | M | 5 |
| . . . | . . . | . . . | . . . |

The following template is associated with the “First Name Popularity by Year from the US Social Security Administration” data set:

Question Statement Template: Rank of [First Name] among the most common first names for newborn [Boys or Girls] in the U.S. in [Year]

Answer: [Rank]

Backstory: According to the Social Security Administration, there were [Count][Boys or Girls] born in the U.S. in [Year] who were named [First Name]. Source: Social Security Administration

### Denormalization

In certain cases, the data import process includes an additional augmentation step which consists of adding fields containing pre-computed or parsed values, which are then used to simplify later queries. This denormalization expands the number records within the database, potentially decreasing the efficiency of the architecture to gain the advantage of richer data linkages. Examples of this data augmentation step include: Adding a “prior day's close” field to Dow Jones data; parsing/normalizing date or number values to allow consistent comparison (for example, mapping both 9/2/55 and Sep. 2, 1955 to standardized date representation: 1955-09-02); or noting former team name(s) in sports data (for example, linking Brooklyn Dodgers data with Los Angeles Dodgers records by adding a bi-directional alias).

Examples of other table-based data sets include: Last Name Counts from US Census Bureau; NFL/MLB/NHL/NBA score records; or Historical Entertainment Award Winners (Grammy, Tony, Emmy, Oscar).

### 3. User Profile/Site Usage Data

For each registered user of the Vital Statistics website, the following information could be recorded in order to build a user profile that could be used in future searches: history of statistics viewed; statistics marked as favorites (“Love It” button); trivia questions or quizzes answered; points accumulated through games; or comments made.

Wizard Engine

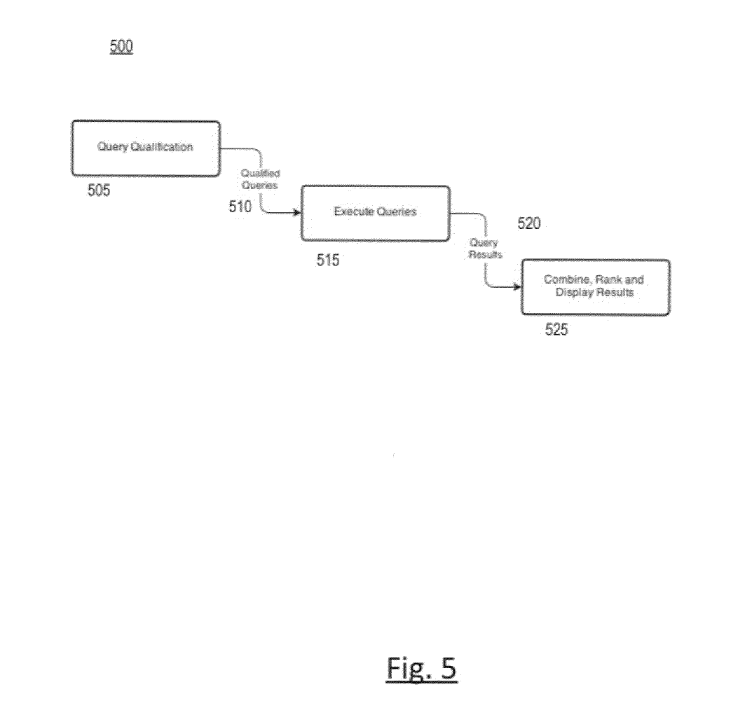

Referring now to FIG. 5, a schematic representation 500 of the three phases of an exemplary wizard software engine is depicted. In particular, the wizard software engine including: (1) at 505, a Query Qualification phase used to determine which queries should be run against which data set(s) to generate at least one qualified query 510; (2) at 515, the Query Execution phase, the queries themselves are run, retrieving data results 520 from the relevant data sets; and (3) at 525, the Combine, Rank and Display Results, results are collated and presented for use in any of the previously described ways.

Query Qualification

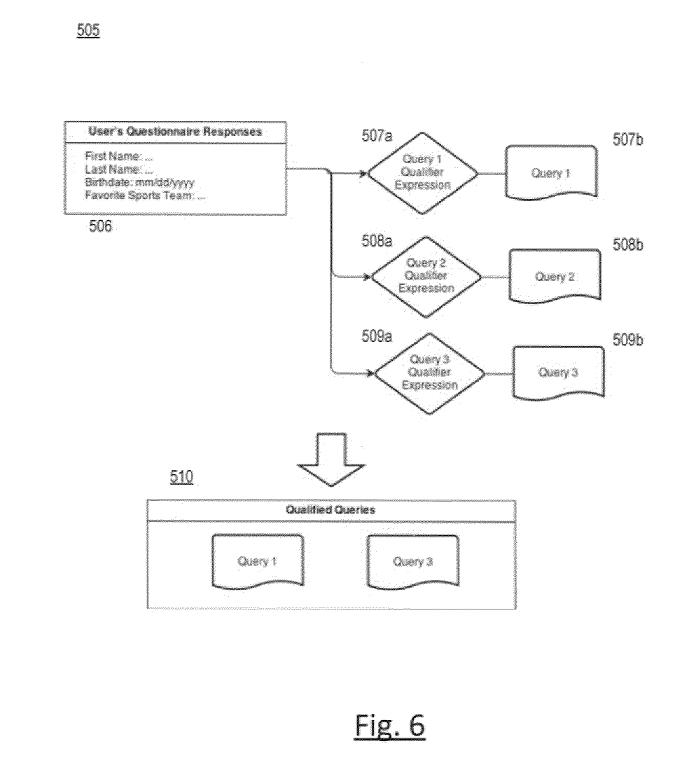

Referring now to FIG. 6, a schematic representation of the exemplary query qualification phase 505 is illustrated. In particular, after a user has fully traversed the questionnaire tree 506 and provided answers to all relevant questions, the wizard may use the responses to build a list of queries to be run against the Vital Statistics database and optionally other 3^{rd} party databases to generate qualified queries. The queries could be selected from the wizard's internal list of query definitions. The list of available queries is populated and maintained manually: queries could be added when new data is loaded into the Vital Statistics database. Other embodiments could include algorithms to add new queries without manual intervention.

Each query definition could comprise of the following: Qualifier Expression: e.g., as depicted in 507a, 508a, and 509a. A Boolean expression, formulated in terms of questionnaire responses. If the qualifier evaluates to “true” for a user's responses, the query is marked for execution; Query Expression: 507b, 508b, and 509b. Database query 510, defined in an appropriate database query language (e.g., SQL or Procedural Statements); and/or Result Template: Used to translate raw data fields into human-readable output. Defined as a parameterized string in the format: question statement/answer/source.

It is important to note that many-to-many relationships exist between user responses, data sets, and queries. Several implications follow, including but not limited to the following: A single user response may be tied to multiple queries; a single query may reference multiple user responses; a query may span multiple data sets; and/or, a data set may be used by many different queries.

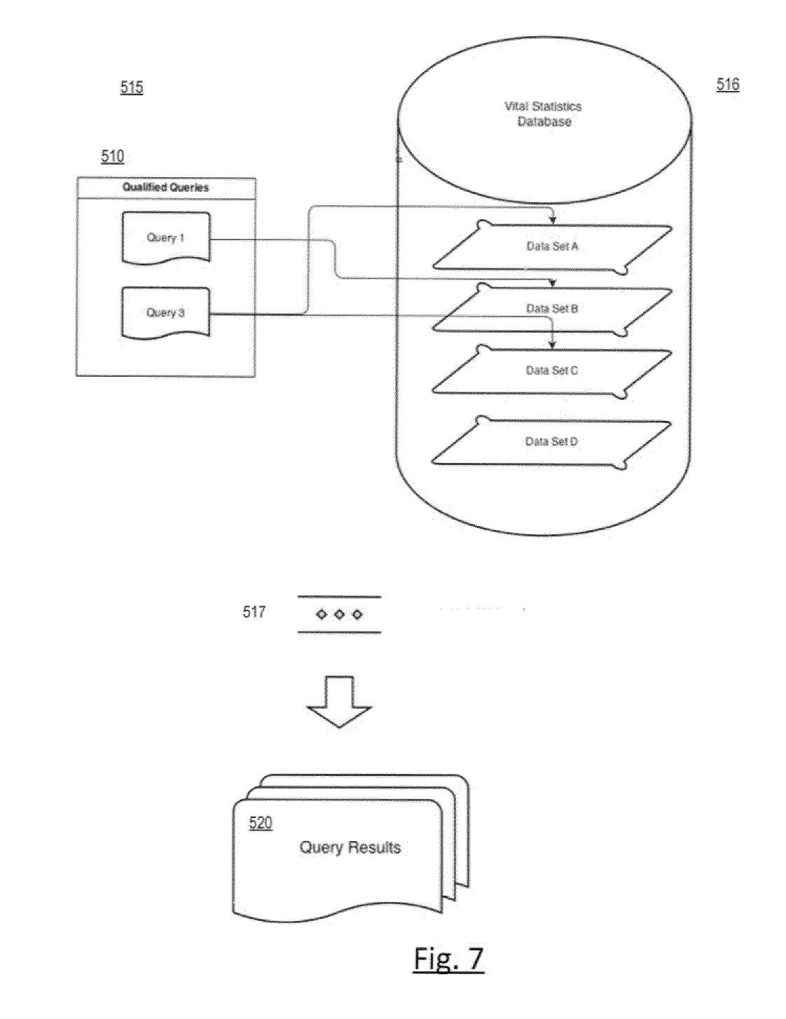

Proceeding now to FIG. 7, a schematic representation of an exemplary execution of the queries phase 515 is depicted. In the example depicted, Query 3 509b retrieves data from Data Sets A and C included in the Vital Statistics Database 516. Query 1 could alternatively reference just one Data Set: B of the Vital Statistics Database 516.

Table 3 provides one specific exemplary qualification protocol 517 to query results 520 according to the following Notation Guide:
A user's questionnaire responses are enclosed in square brackets. For example: [FirstName], [FavoriteSportsTeam], [Gender].
Names of data sets are enclosed in angle brackets, examples: <First Name Popularity Data>, <NFL Scores Data>.
“X in Y” can be translated as “the list Y contains element X”.
isProvided( ) evaluates to “true” if a user response is available, “false” otherwise.
monthYear( ) represents the numeric month and year components of a full date. For example, monthYear (‘May 1, 2013’) evaluates to: ‘05/01’.
Similarly, year( ) represents just the numeric year component of a full date, year (‘May 2, 2013’) evaluates to: 2013.
day( ) represents the calendar day of an input date; day (‘Jun. 4, 1978’) evaluates to: 4.
Query pseudocode statements omit certain syntax details for clarity.

TABLE 3

| | Qualifier Expression | Query Psuedocode | Result Template |
|---|---|---|---|
| 1 | [occasion] in (Birthday, | select Rank | Rank of [First Name] |
| | New Baby) and | from <First Name Popularity by | among the most popular |
| | isProvided(birthDate) | Year & Gender (SSA)> | first names in year of birth |
| | and | where year >= year([BirthDate]) | Answer: Rank |
| | isProvided(FirstName) | and rank = max(rank) | |
| | | and gender = [Gender] | |
| 2 | [occasion] in (Birthday, | select Rank | Rank of [First Names]'s |
| | New Baby) and | from <Birth Date Popularity | birthday among most |
| | isProvided(birthDate) | Data Set> | common in US |
| | and | where MM/YY = | Answer: Rank |
| | isProvided(FirstName) | monthYear([BirthDate]) | |
| 3 | [occasion] in (Birthday) | select Rank | Highest rank of |
| | and isProvided(BirthDate) | from <First Name Popularity by | [FirstName] since person |
| | and | Year & Gender (SSA)> | was born. |
| | isProvided(FirstName) | where year >= year([Birth Date]) | Answer: Rank |
| | | and name = [First Name] | |
| | | and rank = max(rank) | |
| 4 | [interests] in (Sports, | select sum(wins), sum(losses) | Record of [NFL Team] |
| | NFL) | from <NFL Scores Date> | since [First Name]'s birth |
| | and | where teamName = | Answer: Wins-Losses |
| | isProvided(FavoriteSports | [FavoriteSportsTeam] | |
| | Team) | and gameDate >= [BirthDate] | |
| 5 | [interest] in (Sports, | select winOrLoss, finalScore | Outcome of |
| | Baseball) | from <MLB Scores Data Set> | [FavoriteSportsTeam]'s |
| | and | where teamName = [Favorite | game on [First Name]'s |
| | isProvided(FavoriteSports | Sports Team | birth |
| | Team) | and gameDate = [BirthDate] | Answer: winOrLoss, |
| | and isProvided(BirthDate) | | finalScore |
| 6 | [interests] in (Music) and | select artist, work | Grammy winner for |
| | isProvided([MusicGenre]) | from <Grammy Award Data | [MusicGenre] in the year |
| | or | Table> | of [First Name]'s birth |
| | isProvided([FavoriteMusicalArtist]) | where year = year([BirthDate]) | Answer: artist, work |
| | and | and category = [MusicGenre] | |
| | isProvided([BirthDate]) | or nominee = | |
| | | [FavoriteMusicalArtist] | |
| 7 | isProvided([BirthDate]) | select sum(close > prior_close) | Dow Jones performance |
| | | as up_days, | when the market was open |
| | | sum(close < prior_close) as | on [FirstName]'s birthday |
| | | down_days | |
| | | from <Dow Jones Daily Close | |
| | | Data> | |
| | | where date > [BirthDate] | |
| | | and month(date) = | |
| | | month([BirthDate]) | |
| | | and day(date) = day([BirthDate]) | |
| 8 | isProvided([BirthDate]) | select avg(close − prior_close), | Dow Jones point gain or |
| | | min(close − prior_close) as | loss when the market was |
| | | min_gain, | open on [FirstName]'s |
| | | max(close − prior_close) as | birthday |
| | | max_gain, | |
| | | count( ) as total_days | |
| | | from <Dow Jones Daily Close | |
| | | Data> | |
| | | where date > [BirthDate] | |
| | | and month(date) = | |
| | | month([BirthDate]) | |
| | | and day(date) = day([BirthDate]) | |

### Execute Queries/Combine and Rank Results

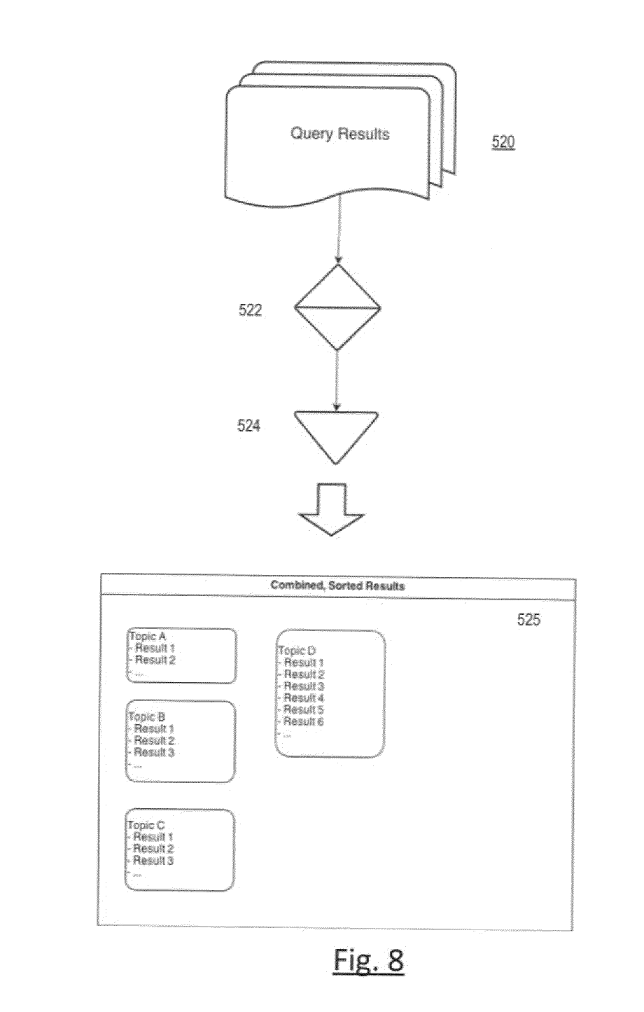

Referring now to FIG. 8, a schematic representation of an exemplary combine, rank, and display results phase is depicted. In one embodiment, after the “Query Qualify” stage 505, selected queries 520 could be executed in parallel according to the protocol 517. Query results could then ranked 522 and combined 524 using defined sort criteria, for example, as shown in the following Table 4:

| | Sort Expression/Formula | Description/Examples |
|---|---|---|
| Date | DateDifference(<result date>, <date of | <date of interest> could be: birth |
| proximity | interest>) | date, wedding date, etc. |
| | | Events/statistics that fall exactly on |
| | | or near a person's birthday or |
| | | anniversary are ranked highest |
| Geographic | Distance(<result location>, <location of | <location of interest> could be: |
| location | interest>) | person's hometown, place of birth, |
| | [computed using latitude/longitude | current residence, wedding site, |
| | pairs] | office, etc. |
| Weighted | SUM(C1 * <view count>, | Descending sort on “Numeric |
| internal score | C2 * <favorite count>, | popularity value”, which is |
| | C3 * <result popularity in wizard>) | computed as a weighted |
| | [C1-Cn are manually-chosen constants] | combination of: site view count, |
| | | “stars”/“favorites” by previous |
| | | site/wizard users, and the number |
| | | of times a result has been retrieved/ |
| | | selected by previous wizard |
| | | users. |

The wizard may present ranked results 525 to the user, grouped by topic, with user interface controls that allow a user to perform the following actions: Fetch more results for a given topic or data source; eliminate results or entire topics from consideration; and/or add specificity to search terms (for example, favorite president: Franklin Roosevelt, not Teddy Roosevelt).

After each of these filter/expand actions performed by the user, the wizard may again execute the “Execute Queries” 515 and “Combine/Rank Results” 525 phases for FURTHER customization. The system may deliver output as a list of statements formatted and ranked, for example, according to individual's interests or self-learned preferences. Users can then manipulate the results by:
Filtering. (For example: I'm not interested in John Deere tractors, I'm interested in other data related to the name John. Another example: Not the Oregon Ducks! I want data about feathered web-footed friends)
Refining. (For example: I would like to see more detail about a certain stock's performance since my birthday.)
Expanding. (For example: Show my more about my favorite MLB team.)
Sorting. (For example: In a list of famous/infamous people who share my birthday or birth month, sort by youngest to oldest.)
Augmenting with freeform entries. (User may provide additional personal data, or highly individualized statistics that are not available in the Vital Statistics database.)

### Application of Results

The final query results 525 may then be put to use in a variety of ways for the generation of a product and/or service. Such embodiments may include, but are not limited to: Design of a physical product on which the results are printed; Embed the results in a personal web page; and/or file export, or export via API to a third-party service.

The above description is illustrative only, not restrictive. Embodiments and aspects thereof may be used in combination with each other. Additionally, various modifications may be made to the above teachings to adapt a solution to a particular problem without departing from the scope of the invention. The hardware and software described herein are merely exemplary embodiments, they are not intended to be limiting. Various additional embodiments could be apparent to those skilled in the art. Therefore, the scope of the invention should be determined with reference to the appended claims, along with the full scope of equivalents to which such claims are entitled.

This above specification of this invention uses various examples to describe several embodiments of the invention, including the best mode. The patentable scope of the invention is defined by the claims, and is not limited by the above mentioned examples. A person skilled in the art may identify other examples that fall within the scope of the invention.

Additionally, the foregoing description of certain embodiments of the present invention may be better understood when read in conjunction with the drawings. The functional blocks in the drawings of various embodiments are not necessarily indicative of the division between hardware circuitry or software modules. Therefore, one or more of the functional blocks may be implemented in a single piece of hardware or software module. For clarity, the various embodiments are not limited to the arrangements and instrumentalities shown in the drawings.

An element or step recited in the singular (i.e., “a” or “an”) should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Additionally, unless explicitly stated to the contrary, embodiments “comprising,” “including,” or “having” an element or a plurality of elements having a particular property may include additional such elements not having that property.

Certain modifications may be made in the methods and systems described herein for correlating databases without departing from the spirit and scope of the invention. Therefore, the above description, including the accompanying drawings, are intended to be interpreted as mere examples illustrating the inventive concept and shall not be construed as limiting the invention.

What is claimed:

1. A system for an intelligent engine portal, the system comprising:
a processor in communication with a communications network and a memory;
the memory storing software code executable on demand, the software code with the processor being operative to:
receive an input from at least one user;
qualify one or more queries based on the received input from the at least one user;
execute the one or more qualified queries;
access, based on the executed one or more qualified queries, multiple databases; and
correlate and combine results from the multiple databases for the generation of a new data set.

2. The system of claim 1, wherein the software code with the processor is additionally operative to:
organize the new data set according to a ranking system, the ranking system determined by the received input.

3. The system of claim 2, wherein the received input from the at least one user includes one or more of a selected occasion, information about a recipient, and a product category.

4. The system of claim 1, wherein the multiple databases include a first database containing statistical data and at least a second database containing one or more of historical data, weather related data, educational data, personal profiles, and public records.

5. The system of claim 1, wherein the new data set is presented in a manner allowing the at least one user to modify the new data set.

6. The system of claim 1, wherein the received input from the at least one user prompts the system to access and gather data from at least one social media profile.

7. The system of claim 1, wherein the processor is additionally operative to one or more of retrieve additional data, rearrange presented data, and delete presented data according to pre-recorded self-learned preferences from the generation of a prior data set.

8. A method for an intelligent engine portal comprising:
receiving an input from at least one user;
qualifying one or more queries based on the received input from the at least one user;
executing the one or more qualified queries;
accessing, based on the executed one or more qualified queries, multiple databases; and
correlating and combining results from the multiple databases for the generation of a new data set that can be presented to the at least one user.

9. The method of claim 8, additionally comprising:
organizing the new data set according to a ranking system, the ranking system determined by the received input.

10. The method of claim 9, wherein the received input from the at least one user includes one or more of a selected occasion, information about a recipient, and a product category.

11. The method of claim 8, wherein the multiple databases include a first database containing statistical data and at least a second database containing one or more of historical data, weather related data, educational data, personal profiles, and public records.

12. The method of claim 8, wherein the new data set is presented in a manner allowing the at least one user to modify the new data set.

13. The method of claim 8, additionally comprising:
accessing and gathering data, in response to the input from the at least one user, from at least one social media profile.

14. The method of claim 8, additionally comprising at least one of:
retrieving additional data, rearranging presented data, and deleting presented data according to pre-recorded self-learned preferences from the generation of a prior data set.

15. The method of claim 8, wherein at least two of the steps are executed in separate computing environments.

16. A method for an intelligent engine portal comprising:
receiving an input from at least one user;
accessing and gathering data, based on the input from the at least one user, from at least one social media profile;
accessing, based on the gathered data from the at least one social media profile, multiple databases; and
correlating and combining results from the multiple databases for the generation of a new data set.

17. The method of claim 16, additionally comprising:
receiving a second input from the at least one user, the second input including one or more of a selected occasion, information about a recipient, and a product category.

18. The method of claim 17, additionally comprising:
organizing the new data set according to a ranking system, the ranking system determined by one or both the first and second received input.

19. The method of claim 16, wherein the multiple databases include a first database containing statistical data and at least a second database containing one or more of historical data, weather related data, educational data, personal profiles, and public records.

20. The method of claim 16, wherein the new data set is presented in a manner allowing the at least one user to modify the new data set.

21. The method of claim 16, additionally comprising at least one of:
retrieving additional data, rearranging presented data, and deleting presented data according to pre-recorded self-learned preferences from the generation of a prior data set by the at least one user.
